(19) United States
(12) Patent Application Publication
(10) Pub. No.: US 2002/0075382 A1
(43) Pub. Date: Jun. 20, 2002

(54) Method and apparatus for implementing a thin-client videophone in a cable television network

(76) Inventor: Yoram Cohen, Givatayim (IL)

Correspondence Address: DR. MARK FRIEDMAN LTD., c/o ANTHONY CASTORINA, 9003 Florin Way, Upper Marlboro, MD, 20772, US

(21) Appl. No.: 09/726,583

(22) Filed: Dec. 1, 2000

(51) Int. Cl. H04N 7/14

(52) U.S. Cl. 348/14.01; 348/14.1; 348/14.13

(57) ABSTRACT

According to the teachings of the present invention there is provided a videophone system utilizing a set-top box (STB) and a server to provide full duplex transmission of audio and video signals over a cable television network, comprising: (a) a first element providing data signals; (b) a compression unit for compressing the signals into a first set of compressed signals; (c) a server designed and configured for converting the first set of compressed signals to a second set of compressed signals, and (d) an STB having a built-in, hardware decompression unit, and operationally connected to the first element and to the server, wherein the STB is designed and configured for: (i) transferring the first set of compressed signals to a server, and (ii) decompressing a set of compressed signals received from the server.

### FIELD AND BACKGROUND OF THE INVENTION

The present invention relates to a video telephone device and, more particularly, to a videophone system that allows full duplex transmission of audio and video signals over a cable television network utilizing existing cable set-top boxes.

Advances in telephony have occurred, such that full duplex audio communication between parties can be supplemented by providing full duplex video communication in tandem with full duplex audio.

It is envisioned that consumers will use videophones to converse with friends and relatives living in distant cities. Videophones are especially desirable for special occasions which consumers often videotape, such as holidays, birthdays, new baby and child related accomplishments, and the like. There are additional features that add to the attractiveness of the videophone. For example, the incorporation of a portable video camera in the videophone system would allow people to walk around their home and not only talk to a person on the other end, but also to show the other person things through the camera. Further, the incorporation of video message recording and retrieval functionality would allow the videophone to act analogously to today's answering machines/voice mail options. Also, remote monitoring could be implemented so that a person could check on various aspects of the home or workplace.

There is a need in the art to easily and inexpensively implement the aforementioned video functionality. The basic problem that has arisen is how to provide video telephony services to a customer's home or office. Primitive stand-alone videophone units which incorporate a screen, camera, and the like into a small telephone device have been implemented. Several drawbacks are associated with these units. It is difficult for the users to appreciate the full breadth of the video, nor are these units easily adapted to realize the advanced features described above.

One viable alternative is to utilize existing cable television networks and display devices. However, to implement the videophone in a cable system, the user must be able to interact with such a device through standard mediums already found in those environments including remote controls, settop boxes, and television sets.

Moreover, many consumers are not computer literate, and consequently, systems which operate on personal computers or act like computers cannot satisfy the needs of a substantial segment of the consuming public.

U.S. Pat. No. 5,999,207 to Rodriguez, et al., discloses a method and apparatus for implementing a user interface for a videophone in a cable television network. A graphical user interface for a videophone in a cable television system allows the user to access the videophone functionalities with an input control device and a television monitor. The user can place a call, receive a call and store/access/call addresses using a remote in conjunction with the graphical user interface display screens. The videophone has several elements including a user interface, a graphics engine, a network interface, a remote control interface, and an output audio/video line connected to a television monitor. The user interface receives and processes control inputs using a microprocessor and the graphics engine generates the display screens using a digital signal processor (DSP). Depending on processing requirements, the DSP may implement the user interface rather than the microprocessor. Also, anti-aliasing fonts are used to generate a high quality display. To save processing cycles, the anti-aliasing fonts may be retrieved from a look-up table rather than being generated in real time. The videophone may be implemented as a plug-in device to a set-top box, a standalone unit, or a standalone unit with a set-top box between the monitor and the videophone unit. When implemented with a set-top box the same remote control unit may be used to control the television and videophone functions.

Thus, U.S. Pat. No. 5,999,207 teaches three possible videophone systems:

1. A stand-alone videophone unit

2. A stand-alone videophone unit connected to a set-top box

3. A stand-alone videophone unit plugged into a set-top box

All of the above-mentioned videophone systems contain a videophone unit that is either stand-alone or connected in some way to a set-top box. More generally, it is observed that known systems to date incorporate a special dedicated videophone unit, which handles compression, decompression, and transmission of video signals. The videophone unit may or may not be connected to a set-top box unit. This approach necessitates that each subscriber have such a unit either as a separate box or as a plug-in unit to a set-top box. Such systems are bulky and expensive, and have proven largely impractical as large-scale consumer products.

Thus, there is a widely recognized need for, and it would be highly advantageous to have, a videphone system that is compact, inexpensive, convenient and reliable, such that large-scale consumer usage could be realized.

### SUMMARY OF THE INVENTION

The present invention is a videophone system utilizing existing cable set-top boxes without the need for a videophone unit, to provide full duplex transmission of audio and video signals over a cable television network. The present invention actually provides an existing set-top box with the functionality of a videophone unit by exploiting the unique properties inherent in the set-top box.

According to the teachings of the present invention there is provided a videophone system utilizing a set-top box (STB) and a server to provide full duplex transmission of audio and video signals over a cable television network, comprising: (a) a first element providing data signals; (b) a compression unit for compressing the signals into a first set of compressed signals; (c) a server designed and configured for converting the first set of compressed signals to a second set of compressed signals, and (d) an STB having a built-in, hardware decompression unit, and operationally connected to the first element and to the server, wherein the STB is designed and configured for: (i) transferring the first set of compressed signals to a server, and (ii) decompressing a set of compressed signals received from the server.

According to further features in the described preferred embodiments, the server is further designed and configured for receiving a third set of compressed signals from a second videophone system and transferring the third set to the STB.

According to still further features in the described preferred embodiments, the server is further designed and configured for converting the third set of compressed signals to a fourth set of compressed signals, and the STB is designed and configured to decompress the fourth set of compressed signals.

According to still further features in the described preferred embodiments, the second set of compressed signals has a MPEG2 format.

According to still further features in the described preferred embodiments, the fourth set of compressed signals has a MPEG2 format.

According to another aspect of the present invention there is provided a method of providing full duplex transmission of audio and video signals over a cable television network, comprising: (a) providing a system including: (i) a first element providing data signals; (ii) a compression unit for compressing the signals into a first set of compressed signals; (iii) a server for routing the first set of compressed signals, and (iv) an STB, operationally connected to the first element and to the server, and having a decompression unit; (b) transferring the first set of compressed signals to the server, (c) routing the first set of compressed signals from the server to a destination STB, and (d) decompressing the first set of compressed signals to obtain a set of decompressed signals.

According to further features in the described preferred embodiments, the method further comprises (e) providing the set of decompressed signals to a monitor.

According to still further features in the described preferred embodiments, the method further comprises (e) routing the first set of compressed signals from the server to a destination server prior to step (c).

According to still further features in the described preferred embodiments, the method further comprises (f) transferring a second set of compressed signals from the server to the STB, and (g) decompressing the second set of compressed signals in the STB.

According to yet another aspect of the present invention there is provided a method of providing full duplex transmission of audio and video signals over a cable television network, comprising: (a) providing a system including: (i) a first element providing data signals; (ii) a compression unit for compressing the signals into a first set of compressed signals; (iii) a server designed and configured for converting the first set of compressed signals to a second set of compressed signals, and (iv) an STB, operationally connected to the first element and to the server, and having a decompression unit; (b) transferring the first set of compressed signals to the server, (c) converting the first set of compressed signals to a second set of compressed signals, and (d) decompressing the second set of compressed signals to obtain a set of decompressed signals.

According to still further features in the described preferred embodiments, the first element of the videophone system includes a video camera.

According to still further features in the described preferred embodiments, the first element of the videophone system includes a device for receiving audio signals.

According to still further features in the described preferred embodiments, the compression unit for compressing the signals is disposed within the STB.

According to still further features in the described preferred embodiments, the compression unit is a microprocessor, a DSP microprocessor, or a dedicated chip, and utilizes a random access memory (RAM).

According to still further features in the described preferred embodiments, the compression unit for compressing the signals is disposed outside of the STB.

According to still further features in the described preferred embodiments, the compression unit for compressing the signals is disposed is disposed within a video camera.

According to still further features in the described preferred embodiments, the compression unit is designed and configured solely for compression.

According to still further features in the described preferred embodiments, the data signals include video signals.

According to still further features in the described preferred embodiments, the data signals include audio signals.

According to still further features in the described preferred embodiments, the method further comprises (e) providing the set of decompressed signals to a monitor.

According to still further features in the described preferred embodiments, the method further comprises (e) routing the first set of compressed signals from the server to a destination server prior to step (c).

According to still further features in the described preferred embodiments, the method further comprises (f) transferring a third set of compressed signals from the server to the STB, and (g) decompressing the third set of compressed signals in the STB.

According to still further features in the described preferred embodiments, the second set of compressed signals has a MPEG2 format.

According to still further features in the described preferred embodiments, the third set of compressed signals has a MPEG2 format.

The present invention successfully addresses the shortcomings of the existing technologies by utilizing standard cable set-top boxes, and by connecting a video camera with a microphone to the high-speed port (e.g., USB, Parallel or FireWire) of the STB, thus dropping the cost per subscriber to merely the cost of the video camera.

The present invention takes advantage of several capabilities of such set-top boxes:

1. The video camera is connected to the high-speed port of the set-top box, either directly or via a compression plug.

2. The cable digital set-top box is designed to decompress (MPEG2) video signals, in real-time, without requiring CPU power.

3. Software modules are downloaded from the headend and are run on the existing CPU of the STB.

4. The graphic engine of the set-top box, which allows the implementation of On Screen Display, is exploited.

In addition, the compression and decompression of video signals, both of which require CPU power, are accomplished in a powerful videophone server in the cable headend, instead of providing a dedicated, physical module for each videophone unit.

The present invention allows a call between two cable subscribers, a call between one cable subscriber and other (non cable) existing videophone systems connected to the Internet such as PCs running videophone software like Microsoft's NetMeeting. The invention is also applicable for videophone system for two-way satellite networks and for cellular videophones. The invention is also applicable for videoconferencing where the “videocall” is between more than two parties.

The invention is also applicable for xDSL based set-top boxes and LMDS or MMDS based set-top boxes. The invention is also applicable for videogame consoles which can also serve as set-top boxes.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of an architecture of the components of a videophone system according to one embodiment of U.S. Pat. No. 5,999,207;

FIG. 2 is a block diagram of an architecture of the components of a videophone system according to another embodiment of the above-referenced U.S. Patent;

FIG. 3 is a block diagram of an architecture of the components of a videophone system according to a third embodiment of the above-referenced U.S. Patent;

FIG. 4 illustrates the interface between the video camera and microphone to the STB, according to the present invention;

FIG. 5 is a flowchart of an exemplary method according to one aspect of the present invention;

FIG. 6 is a flowchart of an exemplary method according to another aspect of the present invention;

FIG. 7 provides a general architecture of the thin-client videophone system according to one aspect of the present invention.

### DESCRIPTION OF THE PREFERRED EMBODIMENTS

The present invention is a videophone system utilizing existing cable set-top boxes without the need for a videophone unit, to provide full duplex transmission of audio and video signals over a cable television network. The present invention actually provides an existing set-top box with the functionality of a videophone unit by exploiting the unique properties inherent in the set-top box.

The principles and operation of the thin-client videophone system according to the present invention may be better understood with reference to the drawings and the accompanying description.

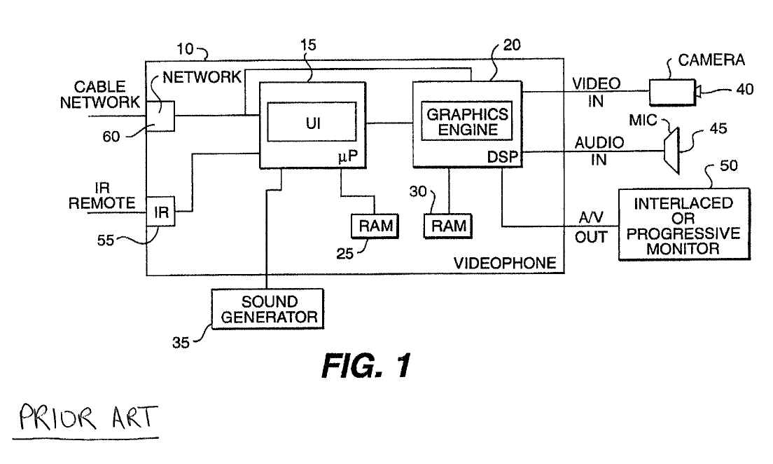

FIG. 1 provides a block diagram of an architecture of the components of a videophone system according to one embodiment of U.S. Pat. No. 5,999,207 to Rodriguez, et al. According to FIG. 1, the videophone 10 includes a user interface (UI) component 15 and a graphics engine 20. In this architecture, the UI 15 and graphics engine 20 reside on different processors. The UI 15 resides on a microprocessor which executes the user interface, whose state is stored in RAM 25. The UI 15 sends UI drawing commands to the graphics engine 20 located on a digital signal processor (DSP). The graphics engine is coupled to a RAM 30. The graphics engine 20 utilizes RAM 30 for encoding/decoding and display of video/graphics. Also, the UI 15 sends commands to a sound generator 35. The sound generator 35 is external to the videophone and responds to commands from the microprocessor and generate a sound when, for example, a user needs to be notified of an incoming call.

The graphics engine 20 on the DSP performs video encoding and decoding and the drawing of graphics. Splitting the videophone functions between the DSP and the microprocessor reduces the computational load on the DSP. An audio/video recording device, such as a camera 40 and a microphone 45 record the pictures and words of the user. The audio/visual data is converted to the appropriate output protocol and transmitted over the cable network to the remote party involved in the call and also outputted locally to an external monitor 50. The videophone 10 generates interlaced (NTSC) or non-interlaced output for display on the external monitor 50 (e.g., TV screen). The audio and video from the videophone can be combined with the television signal under the control of the DSP. For example, the videophone hardware controlled by the DSP can overlay the contents of display buffers on the signal from the cable network, or the videophone hardware can use that signal to construct an entirely new audio/video output.

An IR interface 55 receives IR signals from the remote control and couples those signals to the UI 15. That is, the IR interface 55 is a unidirectional device that generates commands based on the remote input and sends the commands to the UI 15.

A network interface 60 bidirectionally communicates within the videophone 10 with the UI 15 and bidirectionally communicates externally with the cable network via a cable connection. The network interface 60 receives commands from the UI 15 for establishing connections with other IP addresses and handling communications through the cable network. Also, the network interface 60 directs commands to the UI 15 received from the cable network. Also, the network interface 60 passes encoded audio/video streams from the cable network to the graphics engine 20 on the DSP. The graphics engine 20 on the DSP decodes the audio/video and sends the same out to monitor 50. In addition, the graphics engine 20 on the DSP encodes the local signals and sends the same to a remote videophone on the network via the network interface 60. The network interface 60 converts the videophone protocol to the appropriate protocol for transmission over the cable network. Similarly, the network interface 60 converts the cable network protocol to the internal protocol recognized by the videophone components.

The above-described system architecture is cumbersome and expensive, requiring a large and sophisticated videphone unit to be dedicated to the system and to be physically situated at the site (e.g., home) of the user. The above-described videophone unit includes a user interface (UI) component and a graphics engine residing on processors, RAM, an IR interface, and a network interface.

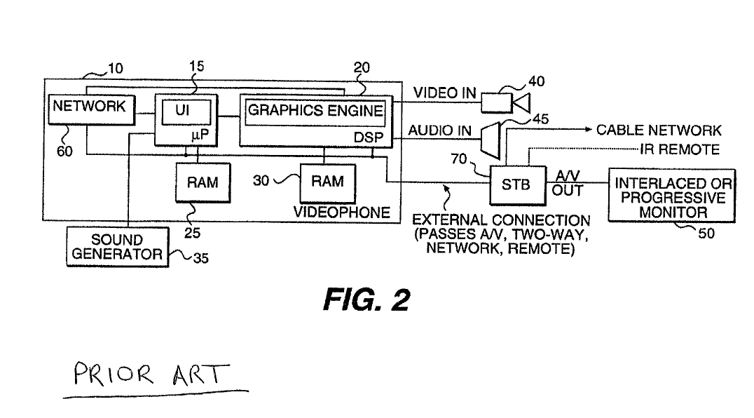

In another embodiment disclosed by U.S. Pat. No. 5,999,207, provided in FIG. 2, a set-top box (STB) 70 can be positioned between the videophone 10 and the monitor 50. The STB 70 can control the overlay of the videophone signal on the television signal. The STB 70 also contains an IR receiver (i.e., a remote control interface) so that a single remote can be used for the STB 70 and the videophone 10. The videophone command signals are generated within the STB 70 when videophone related signals are received from the remote. Then, the command signals are coupled by the STB 70 to the UI 15. Also, the cable network signals are communicated through the STB 70. Videophone communications signals are transmitted to the network interface 60 in the videophone 10 from the cable network via the STB 70, and from the network interface 60 through the STB 70 to the cable network. Also, the STB 70 receives cable television signals which are processed and displayed on the monitor 50 in a conventional manner. The network interface 60 can be located in either the STB 70 or the videophone unit 10. The STB 70 receives input from the cable network via the network interface which it passes to the videophone before outputting the audio/video to the monitor 50. The videophone can then overlay graphics or video on the signal, or reform the audio/video signal entirely as appropriate.

The use of a videophone in conjunction with a STB slightly simplifies the hardware and processing functions of the videophone.

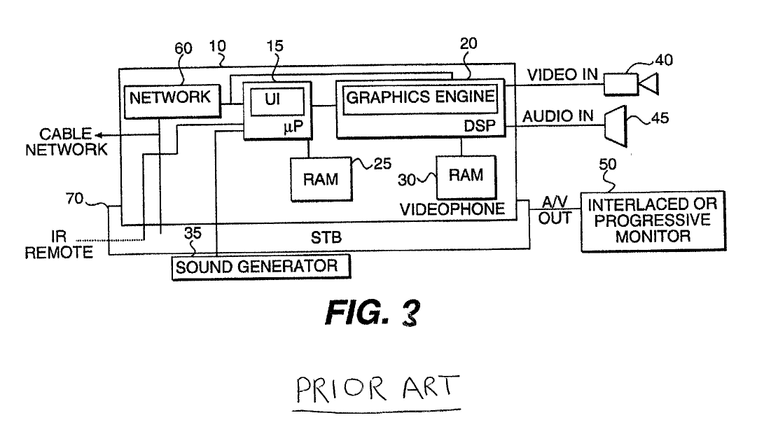

FIG. 3 shows another implementation of the system architecture taught by U.S. Pat. No. 5,999,207. According to this embodiment, the videophone 10 is a plug-in component of the STB 70, sharing both the network and remote connections.

U.S. Pat. No. 5,999,207 further teaches that the architectures provided in FIG. 2 and in FIG. 3 can be modified, such that either the graphics engine 20 alone, or the graphics engine 20 and the UI 15, can be located in the STB 70. In this instance, the videophone DSP need only perform the audio/video transmission functions. Also, the UI 15 may be implemented by the DSP, eliminating the microprocessor so that the DSP performs the videophone operations for both the UI 15 and graphics engine 20.

The transferal of the above-mentioned components and tasks of the videophone to the STB simplifies the structure and reduces the processing functions of the videophone, thereby reducing the physical size and cost of the videophone unit. However, the remaining functions of the videophone—audio and video transmission functions—still require a physical, dedicated videophone.

It must be emphasized that U.S. Pat. No. 5,999,207 employs a dedicated videophone unit in all three system architectures. This makes the cost of such systems very expensive.

In the present invention, however, the STB itself serves as a thin client videophone unit. The instant invention utilizes the unique ability of the STB to decompress MPEG2 video and audio signals, thereby obviating the need for a dedicated videophone unit to be connected to the STB (either as an external unit or as a plug-in as suggested in the referenced invention). Thus, the capabilities inherent in set-top boxes are utilized. The heavy processing, i.e., the compression of video signals and decompression of all video signals (excepting video signals having an MPEG2 format), is substantially inappropriate for current STBs, and is performed in a powerful videophone server in the cable head-end. The heavy CPU power requirements are met by the server, which is capable of providing service for a plurality of users in parallel. Optionally, a compression unit which is connected to the set-top box's existing high-speed port may handle a small part of the CPU requirements. The above-described system design allows a non-dedicated video camera and microphone to be connected directly to a thin client STB (either directly, or optionally via the above-mentioned compression unit).

Before explaining at least one embodiment of the invention in detail, it is to be understood that the invention is not limited in its application to the details of construction and the arrangement of the components set forth in the following description or illustrated in the drawing. The invention is capable of other embodiments or of being practiced or carried out in various ways. Also, it is to be understood that the phraseology and terminology employed herein is for the purpose of description and should not be regarded as limiting.

In the present invention, the compression of the video and audio signals coming from the camera and microphone respectively are compressed either within the camera, within the STB, or by an external plug designed and configured to perform solely a compression function, using a dedicated chip (or generic DSP) with the aid of a random access memory (RAM). The compression encodes the video and audio signals to a first format which is transferred to a server in the cable headend which, in turn, recompresses the first format to a second format (e.g., MPEG2) which is automatically decompressed by the STB.

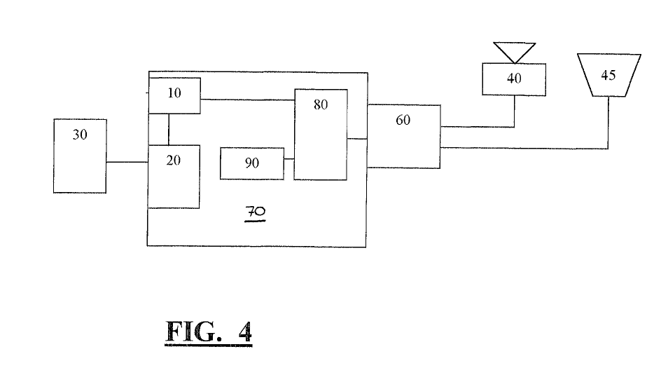

FIG. 4 illustrates the interface between the video camera and microphone to the STB, according to the present invention.

A camera 40 and a microphone 45 transfer the raw video and audio signals to an optional compression unit 60. Compression unit 60 compresses the raw video and audio signals to a first format, which are then transferred to an STB 70. Alternatively, in the absence of compression unit 60, a microprocessor 80 in STB 70 performs the compression. In this case, microprocessor 80 uses a RAM 90 to perform the compression. The compressed audio and video data are sent to the headend videophone server 200 via a cable network interface 10 of STB 70.

Alternatively, the compression may be performed within the camera unit, which then outputs the compressed video and audio signals directly in the first format. An example of a video camera that also performs the compression function is POLYCOM® ViaVideo Portable video camera.

Video and audio signals originating from a second party are transferred to STB 70 via cable network interface 10 in a second compressed format (e.g., MPEG2) that is understood by STB 70. STB 70 decompresses these signals using an embedded, built-in hardware decompression unit 20 (e.g., an MPEG2 decompression unit), and relays the signals to TV unit (external monitor) 50, which is connected to STB 70.

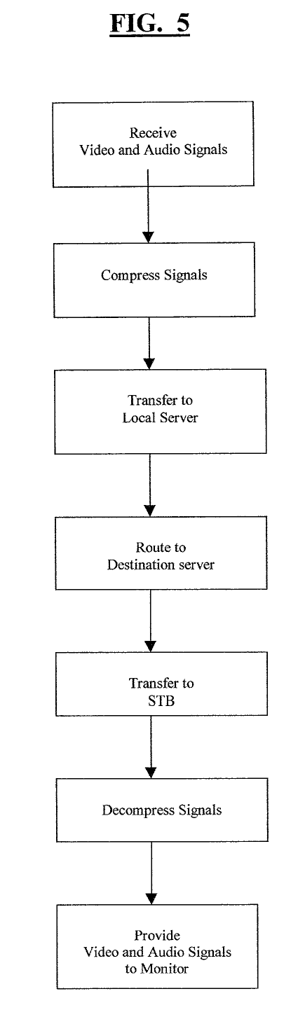

According to the present invention, a method is provided for achieving full duplex video communication in tandem with full duplex audio communication, using the functionality of STBs and a server. A flowchart of an exemplary method according to one aspect of the present invention is provided in FIG. 5. In step 1, the video and audio signals are received from an external device such as a video camera equipped with a microphone. The signals are subsequently compressed (step 2) before being transferred to the local server (step 3).

The use of compressed format is necessary in order to reduce the bandwidth of video & audio signals emitting from the video camera from an order of Mbits/sec to about 64K-384 Kbits/sec. This is needed because all subscribers of each “cable neighborhood” (125 to 2000 subscribers) use a shared upstream channel with a limited capacity of only a few Mbits/sec. Thus, in order to serve many subscribers in a cable neighborhood, who are using the videophone service simultaneously, upstream compression is vital.

The compressed signals are routed to the destination server (step 4), assuming that the destination server is different from the local server. The destination server transfers the compressed signals to the STB of the video receiving unit (step 5). The signals are decompressed using the existing capabilities of the STB (step 6). In step 7, the decompressed video and audio signals are then provided to the monitor for viewing and listening.

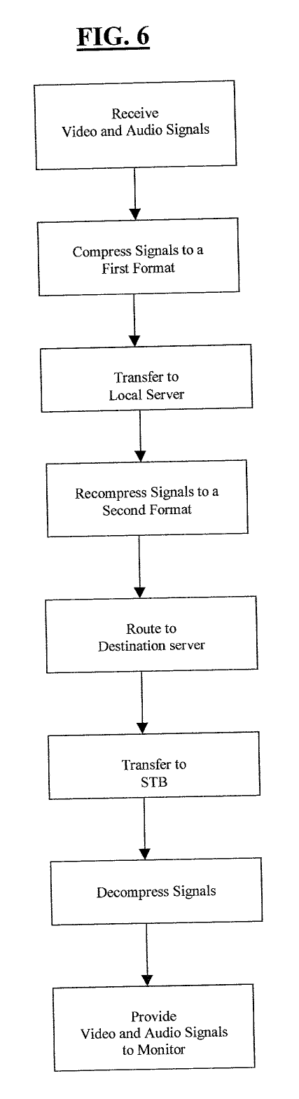

The previous method assumes that the compression step produces a format that is compatible for subsequent decompression. But while the decompression performed in current STBs requires a particular format, namely MPEG2, it may be technologically awkward or unfeasible to perform the compression in a compatible format. The problem of incompatibility is solved by another aspect of the present invention, as shown in the exemplary flowchart provided in FIG. 6.

As described above, the video and audio signals are received from an external device such as a video camera equipped with a microphone in step 1. The signals are subsequently compressed in a first format (step 2) before being transferred to the local server (step 3). In step 4, the compressed signals are recompressed to obtain a second format, compatible with the decompression unit in the receiving STB (see step 7). The recompressed signals are routed to the destination server (step 5), assuming that the destination server is different from the local server. The destination server transfers the compressed signals to the STB of the video receiving unit (step 6). The compressed signals are compatible with the decompression capabilities of the STB, and are subsequently decompressed (step 7) and provided to the monitor (step 8) for viewing and listening.

Alternatively, the recompression step may be performed by the destination server, such that the local server simply routes the video and audio signals, in the first compressed format, to the destination server.

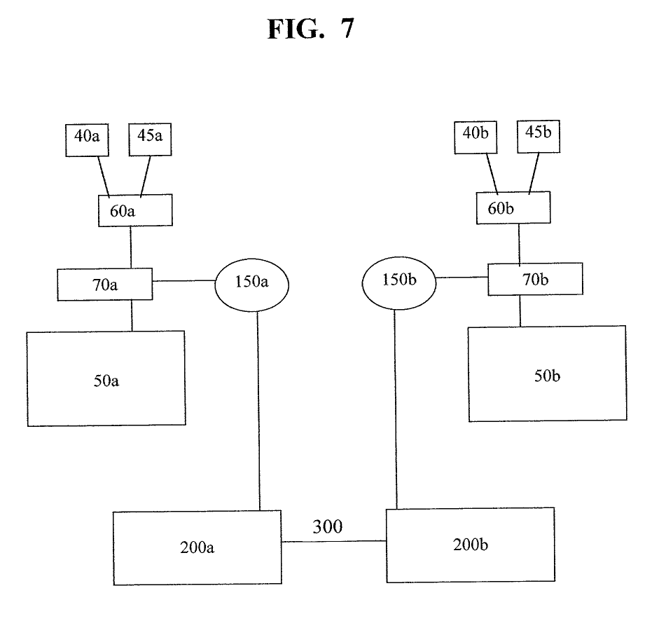

The architecture of the thin-client videophone system according to one aspect of the present invention is provided in FIG. 7. A host party (first party) and a destination party (second party) are respectively equipped with a camera 45a, 45b having a microphone 40a, 40b; a compression plug 60a, 60b; an STB 70a, 70b; and a monitor 50a, 50b (e.g., TV screen). STB 70a of the host party and STB 70b of the destination party communicate to the respective videoservers 200a, 200b via cable networks 150a, 150b. Videoservers 200a, 200b communicate via a shared network 300 (LAN, WAN, MAN or any other network).

Looking by way of example at the host party, camera 45a having microphone 40a is connected to a compression-plug 60a (optionally, compression can be performed inside camera 45a). The video and audio signals emitted from camera 45a and microphone 40a, respectively, are compressed to a first format by compression plug 60a. The compressed output is transferred to STB 70a. The software in STB 70a transfers the compressed video and audio signals via a cable network 150a to a videophone server 200a, which is disposed at the cable headend (center). Each videophone server 200a, 200b handles calls of subscribers belonging to a cable neighborhood. Videophone server 200a identifies the destination party and the associated videophone server, and then transmits the compressed video and audio signals via shared network 300 to videophone server 200b serving the destination party. The destination videophone server 200b recompresses the compressed video and audio signals to a second format which is compatible with STB 70b (currently MPEG2) and sends the recompressed signal to STB 70b of the destination party. Destination party STB 70b decompresses the video and audio signals in the second format and transfers the video and audio signals to monitor 50b. The system is substantially symmetric, such that the communication paths between the first party and the second party can operate in both directions. Thus, video and audio signals from the second party camera 45b and microphone 40b are compressed using compression plug 60b, and are sent via STB 70b to videophone server 200b. Videophone server 200b sends the compressed audio and video to videophone server 200a via shared network 300.

Videophone server 200a recompresses the compressed video and audio signals to a second format which is understood by STB 70a and sends the recompressed signal to STB 70a. STB 70a then decompresses the video and audio signals in the second format and relays the video and audio signals to monitor 50a.

According to the present invention, a subscriber initiates a video call by tuning to the videophone channel (using the controls of the set-top box or the remote control of the set-top box). At this time, a software module that handles videophone calls is downloaded from the headend to the CPU of the set-top and starts execution. Alternatively, this software module may reside permanently in set-top box ROM. The software module uses operating system and graphic engine of the set-top box to display a user interface that allows the subscriber to define the destination videophone number and other parameters such as the image size. When the subscriber wishes to actually establish the call, the software tries to reach the destination set-top box via the headend videophone server. If the destination subscriber is not ready to receive the call, a message will appear on the TV of the subscriber initiating the call. Otherwise, the call is established and video & audio signals will be transferred from one set-top box to the other via the headend videophone server.

In a presently-preferred embodiment, the first compressed video format is H.263. In another presently-preferred embodiment, the first compressed audio format is G.723.1.

The headend videophone server receives the compressed video and audio formats. In the present invention each videophone server may serve one or more “cable neighborhoods”. All videophone servers must be connected together in a network (e.g., including LAN, MAN, WAN, or some combination thereof) so that subscribers served by different videophone servers can communicate with one another. If the destination subscriber is not served by the server serving the origin subscriber, then the compressed video and audio formats are transferred to the appropriate server. The destination server (which may be also the origin server) transforms both signals to a single MPEG2 video format (includes audio), and then transmits the MPEG2 signal to the appropriate subscriber in the downstream video channel. The same is done for the signals emitting from the destination subscriber. In this way the capability of the set-top box to display MPEG2 video and audio signals in real-time is exploited.

The present invention is also applicable to other compression methods to be applied on the video (and audio) signals emitted from the video camera besides H.263 and G.723.1, including, but not limited to, H.261, G.711, G.729, MPEG4, and wavelets-based compression.

Also the destination format may also be other than MPEG2, as long as it is supported by the existing hardware of the destination set-top box or device, e.g., MPEG4 in cellular phones with built-in capability for MPEG4 video decompression.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A videophone system utilizing a set-top box (STB) and a server to provide full duplex transmission of audio and video signals over a cable television network, the system comprising:
(a) a first element providing data signals;
(b) a compression unit for compressing said signals into a first set of compressed signals;
(c) a server designed and configured for converting said first set of compressed signals to a second set of compressed signals, and
(d) an STB having a built-in, hardware decompression unit, and operationally connected to said first element and to said server, said STB designed and configured for:
(i) transferring said first set of compressed signals to a server, and
(ii) decompressing a set of compressed signals received from said server.

2. The videophone system of claim 1, wherein said first element includes a video camera.

3. The videophone system of claim 1, wherein said first element includes a device for receiving audio signals.

4. The videophone system of claim 1, wherein said compression unit for compressing said signals is disposed within said STB.

5. The videophone system of claim 2, wherein said compression unit for compressing said signals is disposed within said video camera.

6. The videophone system of claim 1, wherein said server is further designed and configured for receiving a third set of compressed signals from a second videophone system and transferring said third set to said STB.

7. The videophone system of claim 6, wherein said server is further designed and configured for converting said third set of compressed signals to a fourth set of compressed signals, and wherein said STB is designed and configured to decompress said fourth set of compressed signals.

8. The videophone system of claim 7, wherein said second set of compressed signals has a MPEG2 format.

9. The videophone system of claim 7, wherein said fourth set of compressed signals has a MPEG2 format.

10. The videophone system of claim 5, wherein said compression unit is selected from the group consisting of a microprocessor, a DSP microprocessor, and a dedicated chip, said wherein said compression unit utilizes a random access memory (RAM).

11. The videophone system of claim 1, wherein said compression unit for compressing said signals is disposed outside of said STB.

12. The videophone system of claim 11, wherein said compression unit is designed and configured solely for compression.

13. A method of providing full duplex transmission of audio and video signals over a cable television network, the method comprising:
(a) providing a system including:
(i) a first element providing data signals;
(ii) a compression unit for compressing said signals into a first set of compressed signals;
(iii) a server for routing said first set of compressed signals, and
(iv) an STB, operationally connected to said first element and to said server, said STB having a decompression unit;
(b) transferring said first set of compressed signals to said server,
(c) routing said first set of compressed signals from said server to a destination STB, and
(d) decompressing said first set of compressed signals to obtain a set of decompressed signals.

14. The method of claim 13, further comprising:
(e) providing said set of decompressed signals to a monitor.

15. The method of claim 13, further comprising:
(e) routing said first set of compressed signals from said server to a destination server prior to step (c).

16. The method of claim 13, further comprising:
(f) transferring a second set of compressed signals from said server to said STB, and
(g) decompressing said second set of compressed signals in said STB.

17. A method of providing full duplex transmission of audio and video signals over a cable television network, the method comprising:
(a) providing a system including:
(i) a first element providing data signals;
(ii) a compression unit for compressing said signals into a first set of compressed signals;
(iii) a server designed and configured for converting said first set of compressed signals to a second set of compressed signals, and
(iv) an STB, operationally connected to said first element and to said server, said STB having a decompression unit;
(b) transferring said first set of compressed signals to said server,
(c) converting said first set of compressed signals to a second set of compressed signals, and
(d) decompressing said second set of compressed signals to obtain a set of decompressed signals.

18. The method of claim 17, wherein said data signals include video signals.

19. The method of claim 17, wherein said data signals include audio signals.

20. The method of claim 17, further comprising:
(e) providing said set of decompressed signals to a monitor.

21. The method of claim 17, further comprising:
(e) routing said first set of compressed signals from said server to a destination server prior to step (c).

22. The method of claim 21, further comprising:
(f) transferring a third set of compressed signals from said server to said STB, and
(g) decompressing said third set of compressed signals in said STB.

23. The method of claim 17, wherein said second set of compressed signals has a MPEG2 format.

24. The method of claim 22, wherein said third set of compressed signals has a MPEG2 format.
